(19) United States
(12) Patent Application Publication
(10) Pub. No.: US 2009/0159581 A1
(43) Pub. Date: Jun. 25, 2009

(54) Compressor Profile for Resonance Points System and Method

(75) Inventor: Troy A. Sommerfeld, Neenah, WI (US)

Correspondence Address: FLETCHER YODER (ILLINOIS TOOL WORKS INC.), P.O. BOX 692289, HOUSTON, TX, 77269-2289, US

(73) Assignee: ILLINOIS TOOL WORKS INC., Glenview, IL (US)

(21) Appl. No.: 12/117,674

(22) Filed: May 8, 2008

Related U.S. Application Data
(60) Provisional application No. 61/015,163, filed on Dec. 19, 2007.

(51) Int. Cl. B23K 9/10; F04B 49/00

(52) U.S. Cl. 219/133; 417/1

(57) ABSTRACT

A system is provided that includes a torch power unit. The torch power unit includes a compressor and a controller configured to adjust the compressor based on a profile indicating a resonance point for the compressor. A method is also provided that includes adjusting the compressor to reduce vibrations or movement of the compressor based on a resonance point. A machine-readable medium that includes code that includes instructions to adjust a rate of velocity change based on a resonance point is also provided. A method of operation is provided that includes reducing vibrations associated with a resonance point of the device by increasing the rate of velocity change at the resonance point as compared to non-resonance regions.

### CROSS REFERENCE TO RELATED APPLICATIONS

This application claims priority to and the benefit of U.S. Provisional Application No. 61/015,163, entitled “Compressor Profile for Resonance Points System and Method,” filed Dec. 19, 2007, the disclosure of which is incorporated herein by reference.

### BACKGROUND

The invention relates generally to gas compressors, and more particularly to plasma cutting systems utilizing an air compressor in a single unit.

A variety of systems use compressed gas (e.g., compressed air). For example, compressed air may be used to power tools, such as wrenches, sanders, spray guns, and so forth. By further example, compressed gas (e.g. air) may be used with various torches. A plasma cutting system creates plasma (e.g., high temperature ionized gas) to cut metal or other electrically conductive material. In general, an electrical arc converts a gas (e.g., compressed air) into plasma, which is sufficiently hot to melt the work piece while the pressure of the gas blows away the molten metal. The power output and flow of the gas can affect the performance of the system.

Typically, a compressor is securely mounted to minimize movement during operation. The vibrations or compressor movement may depend on the speed and size of the compressor, as well as the design of the compressor mounts. Unfortunately, the compressor may have one or more resonance points, which can cause excessive vibration and movement of the compressor. In turn, the excessive vibration and movement can cause greater wear and potential damage to system components.

### BRIEF DESCRIPTION

In one embodiment, a system includes a torch power unit that includes a compressor and a controller configured to adjust the compressor based on a profile indicating a resonance point for the compressor.

A method is provided that includes adjusting a compressor to reduce vibrations or movement of the compressor based on a resonance point.

A machine-readable medium is also provided that includes instructions to adjust a rate of velocity change of a compressor based on a resonance point.

In another embodiment, a system includes a torch power unit. The torch power unit includes a plasma cutting circuit, a compressor, a motor coupled to the compressor, and an interface coupled to the plasma cutting circuit and the compressor that includes a plasma torch connection. The torch power unit also includes a controller configured to adjust the compressor based on a profile indicating a resonance point for the compressor.

A method of operation of a device is provided that includes reducing vibrations associated with a resonance point of the device by increasing the rate of velocity change at the resonance point as compared to non-resonance regions.

### DRAWINGS

These and other features, aspects, and advantages of the present invention will become better understood when the following detailed description is read with reference to the accompanying drawings in which like characters represent like parts throughout the drawings, wherein:

FIG. 1 is a partial perspective view of an exemplary plasma cutting system having a gas compressor in accordance with embodiments of the present invention;

FIG. 2 is another partial perspective view of the plasma cutting system as illustrated in FIG. 1, wherein an entire side panel assembly is removed to further illustrate various internal features in accordance with embodiments of the present invention;

FIG. 3 is a block diagram of a compressor controller system in a plasma cutting system in accordance with an embodiment of the present invention; and

FIG. 4 is a graph of compressor speed vs. time illustrating a deceleration profile according to an embodiment of the present invention.

### DETAILED DESCRIPTION

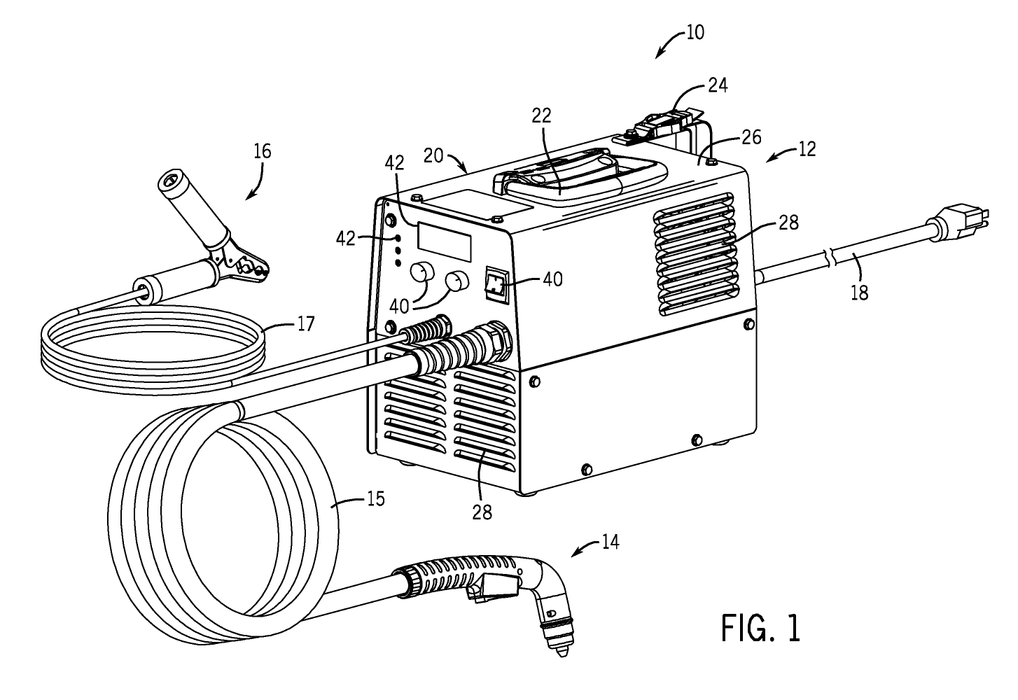

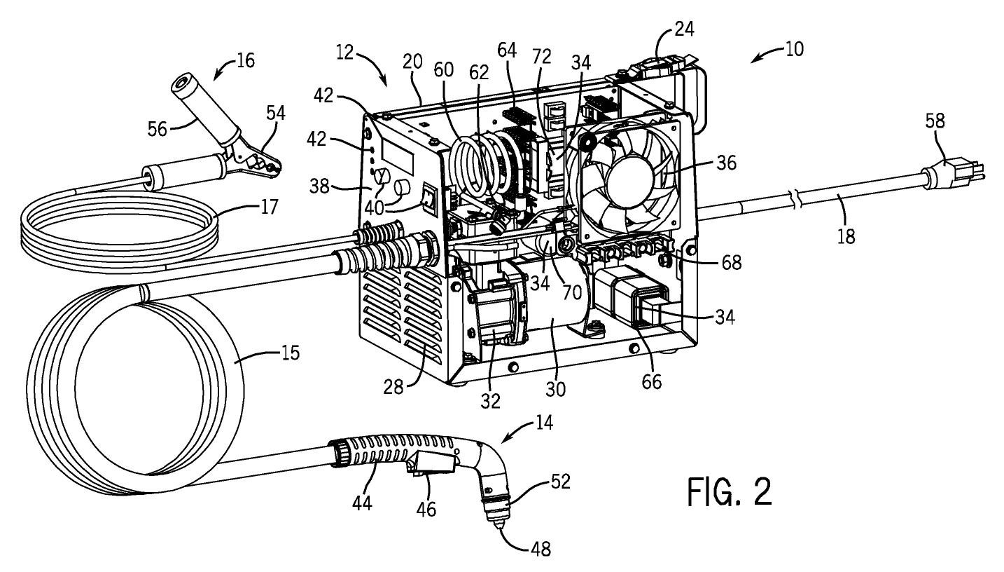

Referring now to the drawings, FIGS. 1 and 2 are partial perspective views illustrating an embodiment of a portable plasma cutting system 10. Specifically, FIG. 1 illustrates the system 10 with access panels completely assembled to close internal components, whereas FIG. 2 illustrates an entire side panel assembly removed to provide a better view of the internal features and components of the system 10. As discussed in further detail below, embodiments of the system 10 include a compressor controller and one or more profiles configured to start-up and shutdown a compressor by accelerating through one or more resonance points. In this manner, the disclosed controller and profiles may substantially reduce adverse vibrations, movement, wear, and potential damage associated with such resonance points.

The illustrated plasma cutting system 10 includes a torch power unit 12 coupled to a plasma torch 14 and a work piece clamp 16 via a torch cable 15 and a work piece cable 17, respectively. The torch power unit 12 may be coupled to a power source (e.g., a power grid or a motor-driven generator) via a power cable 18. The power source may provide a pilot current to a cathode, such as a movable electrode, and to the anode, such as the nozzle of the torch 14, that are forced into contact via a spring. After electrical current begins to flow from the electrode to the nozzle of the torch 14, gas or air supplied to the torch 14 counteracts the spring force and moves the electrode away from the nozzle. This breaks the electrical contact between the electrode and the nozzle and creates the pilot arc. Also, as the electrode moves away from the nozzle, it opens a nozzle orifice (connected to the air supply), and a plasma jet is created. The plasma jet causes the arc to transfer (at least in part) to the work piece held by the clamp 16, thus initiating cutting. Electronics in the power source sense when the arc has transferred and then supply a main cutting current of greater amperage after the transfer has occurred. Also, the tip of the torch 14 is disconnected (electrically), interrupting the pilot current path. Thus, the current is used to cut the work piece, and follows a path including the positive terminal, the work piece and the electrode. For example, the power unit 12 may be configured to supply a suitable voltage and current to create an electrical circuit from the unit 12, along the cable 15 to the torch 14, across a gap between the torch 14 and a work piece (e.g., as an electrical arc), through the work piece to the clamp 16, through the cable 17 back to the unit 12. In alternate embodiments, a non-moving electrode torch may be used in which a pilot arc is created via a high voltage and/or high frequency circuit, so that the high voltage may cause the arc to jump from the non-moving electrode to the nozzle. In yet other embodiments, any suitable torch and starting technique may be used.

The power unit 12 includes an enclosure 20 defining a generally closed volume to support various circuits, sensor features, control features, and gas supply features (e.g., air compressor). As discussed in detail below, the illustrated system 10 includes a variety of features to improve portability, serviceability, reliability, and control of the plasma torch 14 and the components within the single enclosure 20 of the system 10. For example, the system 10 may include sensors and controls to adjust the power unit 10 to account for various conditions, e.g., altitude, temperature, pressure, vibration, and so forth. The illustrated system 10 also may include a handle 22 on the top side of the enclosure 20 to enable easier transportation of the system 10. The illustrated system 10 also may include a latching mechanism 24 that secures a top portion 26 (e.g., removable access panel) of the enclosure 20. The latching mechanism 24 that may secure the torch 14, the cable 17, the clamp 16, and/or the power 18. The enclosure 20 may also include vents 28 to relieve heat and/or pressure inside the system 10. Additional vents may be located on other panels of the enclosure 20.

To provide for operation of the plasma torch 14, the system 10 may include a compressor motor 30, such as a DC or AC motor that may include brushed, brushless, switched, reluctance, or any other suitable type of motor, and a compressor 32. For example, the compressor 32 may include a positive displacement compressor, such as reciprocating compressor (e.g., piston-cylinder), a rotary screw compressor (e.g., helical screws to compress a gas continuously without a storage tank), or a diaphragm compressor, or the like. In certain embodiments, the system 10 may include a flow or pressure meter or like sensor configured to monitor output of the compressor 32. The system 10 also may include sensors, such as a pressure sensor, a temperature sensor, a vibration sensor, or a combination thereof, to provide feedback used to adjust the motor 30, the compressor 32, power electronics 34, or a combination thereof. The power electronics 34 may be configured to condition and provide power to the torch 14 and the compressor 32, and may include transformers, circuit boards, and/or other components. A fan 36 may also be included inside the system 10 to provide air circulation and cooling to the system 10. Additionally, as depicted in FIG. 2, the fan 36 may be located next to one of the vents 28 to optimize air circulation. Additional fans 36 may be included at other locations inside or outside the enclosure 20.

In the illustrated system 10, a control panel 38 is included at an end of the power unit 12. The control panel 38 may include various control inputs, indicators, displays, electrical outputs, air outputs, and so forth. In an embodiment, a user input 40 may include a button, knob, or switch configured to enable selection of a mode of operation (e.g., plasma cut, weld, etc.), power on/off, polarity, an output current level, gas (e.g., air) flow rate, gas (e.g., air) pressure, gas type, a work piece type, a control type (e.g., manual or automatic feedback control), or a combination thereof. The control panel 34 may also include various indicators 42 to provide feedback to the user. For example, the indicators 42 may include one or more light emitting diodes (LED) and/or liquid crystal displays (LCD) to display on/off status, current level, voltage level, gas (e.g., air) pressure, gas (e.g., air) flow, environmental conditions (e.g., altitude, temperature, pressure, etc.), or any other parameter. Additionally, the indicators 42 may include an LED or LCD that displays a trouble or warning indicator if there is a problem with the system 10. Embodiments of the control panel 38 may include any number inputs and outputs, such as welding or cutting methods, air compressor settings, oil pressure, oil temperature, and system power.

Further, the user inputs 40 and indicators 42 may be electrically coupled to control circuitry and enable a user to set and monitor various parameters of the system 10. For example, the indicators 42 may display environmental conditions (e.g., altitude, temperature, pressure, etc.) that prompt a user to manually adjust the current, gas flow rate, gas pressure, or other operational parameters, or a combination thereof. The indicators 42 also may prompt a user to enable the system to perform automatic adjustments in view of the sensed environmental conditions. For example, one of the inputs 40 may enable a user to select an automatic feedback control mode based on environmental conditions and/or sensed parameters of the system 10 (e.g., compressor output, vibration, etc.). In one embodiment, the automatic feedback control makes components, such as the motor 30, the compressor 32, a generator, and so forth accelerate through the resonance point of the system. For example, the system starts the motor 30 and vibration is sensed in the motor 30, compressor 32, or generator, or a combination thereof, and the system may accelerate to greater speed to reduce undesirable effects of the vibration (e.g., resonance point). Similarly, if the system shuts down or reduce the speed of the motor 30, the compressor 32, or generator, and vibration is sensed, and the system may decelerate the motor 30 to a slower speed to reduce the undesirable effects of vibration (e.g., resonance point).

The plasma torch 14 includes a handle 44, a locking trigger 46, a tip 48, a retaining cap 52, as well as an electrode inside the torch 14. The clamp 16 comprises an electrically conductive material clamping portion 54 having insulated handles 56. The power cable 18 includes a plug 58 for connection to a power source such as a wall socket or a motor-driven generator. The plug 58 may be configured to work with a variety of sockets or outlets, and the system 10 may receive different power sources, such as AC 50/60 Hz, 400 Hz, single or three phase 120V, 230V, 400V, 460V, 575V, etc.

Turning now in more detail to FIG. 2, the system 10 includes the fan 36, the gas compressor 32, a heat exchanger 60, pneumatic coupling 62, and heat sinks 64. Additionally, the power electronics 34 includes ground fault circuit interrupt (GFCI) dual inductor 66, primary terminal block 68, bus capacitor 70, and transformer 72. Further, the system 10 may include additional inductors, terminals, capacitors, transformers, or other electrical components and is not limited to the components illustrated in FIGS. 1-2.

As mentioned above, the gas compressor 32 may be a reciprocating compressor (e.g., piston-type compressor), a diaphragm compressor, or a rotary screw compressor, or the like. In the illustrated embodiment, the gas compressor 32 is a single stage reciprocating compressor. The compressor 32 may include or may be connected to the DC or AC motor 30 that is connected to power electronics 34 inside the system 10, such that the motor 30 drives the compressor 32. The gas compressor 32 may be rigidly mounted inside the enclosure 20 using compressor mounts such as rubber mounts, plastic mounts, metal mounts, or any other material. The compressor mounts may be configured to dampen vibrations of the compressor or to allow slight movement of the compressor during operation.

In the illustrated embodiment, the gas compressor 32 intakes and compresses air directly from the atmosphere, such as via a filter, and may use one of the vents 28 as an intake vent to enable air to flow into the compressor 32. The gas used by the compressor 32 may be a gas, such as nitrogen, argon, hydrogen, oxygen, or any combination thereof. Accordingly, the gas compressor 32 may provide a direct supply of compressed gas (e.g., air) on-demand to a desired application, such as the plasma torch 14. Thus, the torch 14 may consume air directly from the unit 12 without the air being compressed into a tank downstream of the compressor 32. However, alternative embodiments may include an air tank configured to store the compressed air.

To ensure reliability and performance for the system 10, various temperature sensors (e.g., thermistors) may be included inside the enclosure 20 to measure the temperature of various components. For example, the system 10 may include a temperature sensor configured to measure the temperature of the motor 30, the compressor 32, the power electronics 34, atmospheric air, and so forth. In addition to each temperature sensor, the system 10 may include control and/or monitoring logic to receive signals from the temperature sensors and perform the appropriate action or indication. For example, if the signal from one or more of the temperature sensors (e.g., thermistors) exceeds a threshold temperature or voltage for a component, then the control and monitoring logic may provide a visual warning by activating a LED or LCD 42 on the control panel 38. If the signal from a temperature sensor (e.g., thermistor) exceeds another threshold temperature or voltage and/or the signal remains above the threshold for a specific duration, then the control and monitoring logic may shutdown the system 10 or that component. The control and monitoring logic may prevent use of the system 10 until the signals from the temperature sensors fall below the threshold levels.

The system 10 may also include control circuitry to coordinate functions of the system components. For example, the system 10 may include control circuitry in the vicinity of the control panel 34. In one embodiment, the control circuitry may include a processor, memory, and software code configured to control and or coordinate operation of the system 10.

The system 10 may include cooling components such as the heat sinks 64 and may include active cooling via the fan 36. The heat sinks 64 may be mounted such that airflow from the fan 36 circulates air around the heat sinks, further enhancing the cooling capability of the heat sinks 64. As discussed above, additional fans may be included in other locations in the system 10. Similarly, additional heat sinks may be placed inside the system 10 depending on those areas that need passive cooling and/or cannot be cooled by any of the fans in the system 10. Thus, in other embodiments, the system 10 may include any number and combination of active and passive cooling components.

During operation of the system 10, a user first connects the system to a power source, such as a wall socket, via the power cable 18 and the plug 58. A user may then turn on the system 10 via the user input 40. The compressor 32, fan 36, and other components of the system 12 receive power from the power electronics 34 and begin operation after the user input is activated. A user then attaches the clamp 16 to a work piece (e.g., metal or other material) to be cut. To begin cutting the work piece, the user places the cutting torch 14 adjacent to the work piece and activates the trigger 46, which may involve raising a locking mechanism to free the trigger 46 before depressing the trigger 46. Compressed gas from the gas compressor 32 passes through the heat exchanger 60 and through the torch cable 15 and out the tip 48 of the torch 14. As discussed above, a pilot current may be supplied between a moveable electrode and the nozzle of the torch 14, thus establishing a pilot arc when the moveable electrode is pushed away from the nozzle of the torch 14 by the gas supplied by the compressor 32. As the electrode moves away from the nozzle of the torch, gas flowing through the torch 14 is energized into a plasma jet which in turn transfers the arc to the work piece.

The electrical arc heats up the gas from the compressor 32, converting it to plasma that is hot enough to cut the work piece. As the user moves the torch 14 across the work piece by dragging, using a drag shield, standoff guide, or the like, the material is cut as the plasma moves through the material. The thickness of the material being cut may be limited by the power of the system 10, the output of the compressor 32, and the torch 14. In addition to supplying the plasma, the compressed gas from the compressor 32 cools the torch 14 and blows away molten material (e.g., molten metal). At the end of the cut, the user releases the trigger 46 of the torch 14. Gas may continue to flow through the torch 14 for a period of time sufficient to cool the consumables, in a state known as “postflow.” The postflow cools the torch 14 and ensures that any remaining material is blown away. After postflow, a user may shutdown the system 10 via one or more user inputs 40 on the control panel 38. As discussed further herein, shutdown of the system 10 may include shutting down the motor 30 and compressor 32, such that the motor 30 and/or the compressor 32 passes through one more resonance points in the system 10 that correspond to one or more rpm ranges. Similarly, during start-up of the motor 30 and compressor 32 these resonance points may also be encountered.

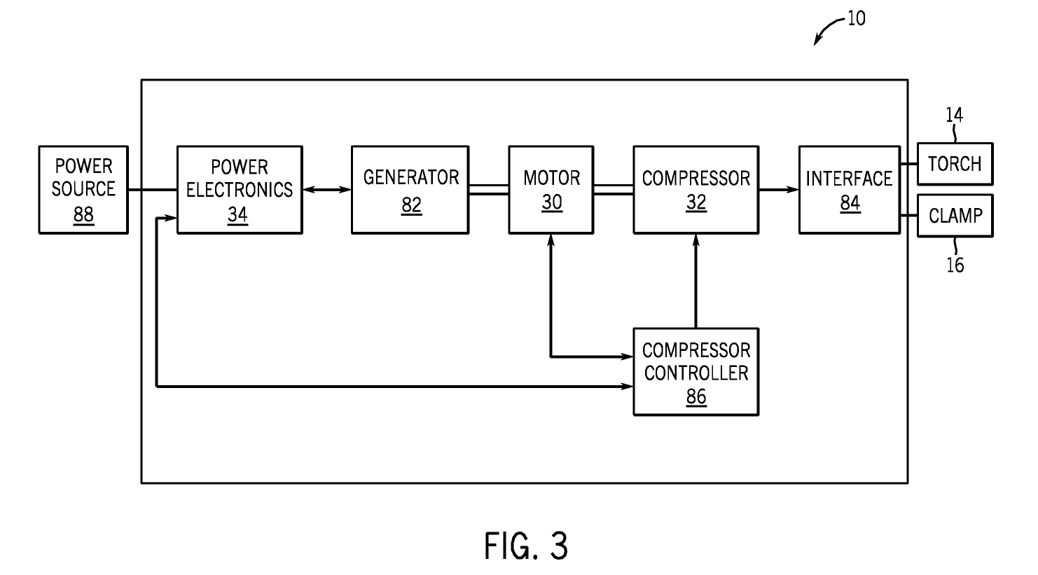

FIG. 3 is a block diagram of a compressor control system that includes a control feature (e.g., software control) to minimize movement and vibration of a compressor within a plasma cutting system 10 in accordance with an embodiment of the present invention. However, the disclosed control feature may be used to minimize movement and vibration in a variety of systems, such as a stand-alone compressor, a stand-alone generator, a power unit having a compressor and/or generator, and so forth. The control feature is not limited to compressors or plasma cutting systems. The control feature may include code or instructions stored on a machine-readable or tangible medium, such as memory. The control feature may be incorporated into a controller or circuit. The illustrated embodiment includes the power electronics 34, a power generator 82, the motor 30, the compressor 32, an interface 84, and a compressor controller 86.

The illustrated system 10 is connected to a power source 88, such as a power grid or a power generator. The compressor 32 is driven by the motor 30, which may be controlled by the compressor controller 86. As discussed above, the motor 30 may be an electric motor, such as a DC or AC motor, or a gas combustion engine. For example, the motor 30 may include a two-stroke or four-stroke spark-ignition engine, which includes one or more reciprocating piston in cylinder assemblies, a carburetor or fuel injection system, and so forth. Some embodiments of the system 10 may include the power generator 82 built-in or integrally disposed within the enclosure 20 of the power unit 12. Thus, the motor 30 may drive both the compressor 32 and the electrical generator 82, thereby making the power unit 12 completely portable for use in remote locations. However, other embodiments may exclude the generator 82 to reduce the size, weight, and cost of the power unit 12. Additionally, power electronics 34 provide the power management functions for the system 10. In some embodiments, the power electronics 34 include a plasma cutting circuit, a welding circuit, an induction heating circuit, a power conditioning circuit, a user input/interface circuit, a power generator circuit (e.g., if the unit 12 includes the generator 82), a vibration control circuit (e.g., accelerate the resonance points of motor 30, compressor 32, and/or generator 82), or a combination thereof.

The power electronics 34 and/or the compressor controller 86 may control and monitor the speed or output of the compressor 32 and/or motor 30, and may also control and monitor the voltage, current, vibration, or other parameter of the compressor 32 and/or motor 30. The power electronics 34 and/or the compressor controller 86 may change these parameters in response to signals received by a user through the interface 84. For example, if a user activates or turns on the system 10 and the compressor 32 through the control panel/interface 84, the compressor controller 86 may start-up the motor 30 and the compressor 32. Similarly, a shutdown signal received from the interface 84 in response to a user turning off the system 10 would result in the compressor controller 86 shutting down the motor 30 and compressor 32. In one embodiment, the controller 86 may include a microprocessor having one or more channels configured to control the compressor 32 and/or the motor 30. For example, one channel may be used for the gate drive of the motor 30, another may be used for the current limit, as discussed further below, and other channels may be used with any other desirable control and/or signal.

As discussed above, various operating speeds of the system components (e.g., motor 30, compressor 32, or generator 82) may affect a resonance point in the system 10 leading to vibrations or movement. The excessive vibration and/or movement of the compressor 32 or other components of the system 10 at a resonance point may cause undesirable wear and possible damage to components. For example, solder joints between electrical components and circuit boards may be stressed and/or weakened if subjected to the excessive vibration of a resonance point for a length of time. To minimize the duration of the resonance points, the compressor controller 86 may include a deceleration or shutdown profile for shutting down the compressor 32 and lowering the speed of the motor 30 and compressor 32. The shutdown profile may include a greater rate of deceleration through one or more resonance points, thus minimizing any movement or vibration that may occur as a result of operating the compressor 32 at the resonance point. In other words, upon sensing or approaching a known resonance point, the deceleration profile may substantially increase deceleration to move through the resonance point in a shorter amount of time. Additionally, reducing the duration of operation of the compressor 32 in the resonance points may reduce wear and stress on the compressor mounts or other mounting hardware.

In addition to a deceleration profile, the compressor controller 86 may also include a start-up acceleration profile for start-up of the motor 30 and compressor 32. The profile may also include increasing the rate of acceleration of the compressor through the resonance points of the system 10. Both the shutdown profile and start-up profile may begin after a preprogrammed delay. For example, before deceleration of the motor 30 and the compressor 32, the compressor controller may wait for postflow to complete so that the adequate cooling of the torch 14 is ensured before shutting down the compressor 32. In other embodiments, profiles may be used for changes in speed of the compressor, and not just for start-up or shut-down of the compressor. For example, a change in speed, such as increasing the speed of the compressor so that the output of the compressor is increased, may also cause a resonance point in the system. In this instance, increasing the rate of acceleration can also alleviate vibration and movement while passing through such a resonance point.

In one embodiment, the resonance points may be determined experimentally. For example, the compressor 32 may be operated at various speeds, and the frequency of the system 10 at various points may be measured. Excessive high frequencies may be indicative of resonance points and correlated to a speed (rpm) of the motor 30 or compressor 32. Thus, a deceleration profile or start-up profile for the compressor controller 86 can be created based on the correlation between resonance points and speed of the compressor 32 and/or motor 30. In one embodiment, the resonance points may be about 70 Hz, and the compressor speed may range from about 3500 to 4500 rpm. In other embodiments, the resonance points may be determined from one or more vibration sensors positioned throughout the system 10. In such an embodiment, the profiles and associated resonance points may be adjusted dynamically in response to changes in the system 10, such as wear of compressor mounts, uneven surfaces, etc.

In one embodiment, the acceleration portion of the operating profiles for the compressor 32 may be implemented via voltage control of the motor 30. For example, the relationship between voltage and rpm is directly proportional to the relationship between voltage and time (ΔV/Δt). Thus by increasing the change in voltage (ΔV) for a given duration of time (Δt), the change in speed (either during start-up or deceleration) of the motor 30 and the compressor 32 may be also increased for that duration of time.

In some embodiments, a current limit may be used to limit current provided to the motor 30. For example, the current limit may be a function of time, and thereby reduce the inrush current drawn by the motor 30 on startup. After a specific start time has elapsed, the current limit may be removed and other parameters, such as slew rate, e.g., change in voltage, may used to control the motor 30 and thus the rate of acceleration and other transition areas according to the profiles discussed above. In other embodiments, multiple current limits may be used to accelerate and/or decelerate the motor 30.

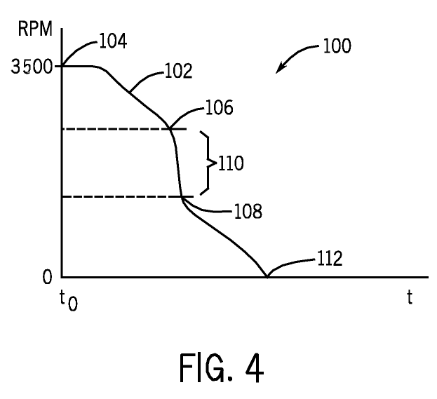

FIG. 4 depicts a graph 100 of compressor speed vs. time according to an embodiment of the present invention. The graph of FIG. 4 illustrates a deceleration profile 102 that maintains regular shutdown deceleration through the non-resonance points yet decelerates at a greater rate through resonance point. At t0, or before the compressor controller 86 has started the shutdown of compressor 32, the compressor 32 is at an operating speed of about 3500 rpms as indicated at point 104.

The resonance points are indicated by the areas on the y-axis between points 106 and 108. As time elapses, the speed (rpm's) of the compressor 32 decreases during the deceleration profile. At the point 106, a resonance point, the deceleration profile starts to increase the rate of deceleration through the resonance points, as indicated by the steep slope portion 110 of the deceleration profile 102. Thus, for a given duration of time on the x-axis, the change in speed (rpm's) of the portion 110 is much faster than the other areas of the deceleration profile 102. At the end of the resonance point, as indicated by point 108, the steep slope portion 110 ends and the deceleration profile 102 continues normally until the speed of the motor reaches 0, as indicated by point 112.

As discussed above, a start-up profile may also be included to accelerate at a greater rate through the resonance points. Thus, a profile similar to the profile 102 may be included and executed by the compressor controller 86. However, for a start-up profile, at t0 the compressor speed is at 0 rpm's, and the profile accelerates the motor 30 and compressor 32 until the operating speed is reached at about 3500 rpms.

It should be appreciated that the compressor control system and profiles are applicable to other portable systems using a gas compressor. For example, an engine-driven welding system that includes an engine, generator, and compressor, may also implement a deceleration profile and an acceleration profile using the controller and logic described herein.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
a torch power unit, comprising:
a compressor; and
a controller configured to adjust the compressor based on a profile indicating a resonance point for the compressor.

2. The system of claim 1, wherein the profile comprises a deceleration profile, an acceleration profile, or combination thereof.

3. The system of claim 1, wherein the profile is configured to minimize vibrations and/or movement of the compressor associated with the resonance point.

4. The system of claim 1, wherein the profile includes a greater rate of velocity change at the resonance point as compared to non-resonance regions.

5. The system of claim 1, wherein the resonance point comprises about 70 Hz.

6. The system of claim 1, wherein the profile comprises a start-up profile, a shutdown profile, or combination thereof.

7. The system of claim 1, wherein the torch power unit comprises a plasma cutting circuit.

8. The system of claim 1, wherein the torch power unit comprises a welding circuit.

9. The system of claim 1, wherein the torch power unit comprises a power generator.

10. The system of claim 9, comprising a motor coupled to both the power generator and the compressor.

11. The system of claim 1, wherein the compressor comprises a reciprocating compressor, a rotary screw compressor, or a diaphragm compressor.

12. A method of operation, comprising:
adjusting a compressor to reduce vibrations or movement of the compressor based on a resonance point.

13. The method of claim 12, wherein adjusting comprises varying speed of the compressor based on a profile.

14. The method of claim 12, wherein adjusting comprises increasing a change in speed of the compressor for a duration.

15. The method of claim 12, wherein adjusting comprises increasing a rate of acceleration during startup of the compressor.

16. The method of claim 12, wherein adjusting comprises decreasing a rate of deceleration during shutdown.

17. The method of claim 12, wherein adjusting the speed of the compressor comprises adjusting the voltage of a motor coupled to the compressor.

18. The method of claim 13, wherein the profile comprises a delay before adjusting the speed of the compressor.

19. The method of claim 12, comprising flowing compressed gas to a torch

20. The method of claim 12, wherein adjusting the speed of the compressor comprises adjusting the current of a motor coupled to the compressor.

21. A computer readable medium, comprising:
code disposed on the computer readable medium, wherein the code comprises instructions to adjust a rate of velocity change of a compressor based on a resonance point.

22. The computer readable medium of claim 21, wherein the code comprises a velocity profile having a greater rate of velocity change of the compressor for a duration during shutdown of the compressor or start-up of the compressor in association with the resonance point.

23. A system, comprising:
a torch power unit, comprising:
a plasma cutting circuit;
a compressor;
a motor coupled to the compressor;
an interface comprising a plasma torch connection, wherein the interface is coupled to the plasma cutting circuit and the compressor; and
a controller configured to adjust the compressor based on a profile indicating a resonance point for the compressor.

24. The system of claim 23, wherein the profile comprises increasing the rate of acceleration during start up, decreasing a rate of deceleration during shutdown, or a combination thereof.

25. A method of operation of a device, comprising:
reducing vibrations associated with a resonance point of the device by increasing the rate of velocity change at the resonance point as compared to non-resonance regions.
